(19) United States
(12) Patent Application Publication
(10) Pub. No.: US 2008/0165683 A1
(43) Pub. Date: Jul. 10, 2008

(54) METHOD, SYSTEM, AND PROGRAM PRODUCT FOR ENHANCING NETWORK COMMUNICATIONS BETWEEN ENDPOINTS

(76) Inventors: Debanjan Saha, Mohegan Lake, NY (US); Zon-Yin Shae, South Salem, NY (US); Anees Shaikh, Yorktown Heights, NY (US); Kunwadee Sripanidkulchai, Austin, TX (US)

Correspondence Address: HOFFMAN WARNICK LLC, 75 State Street, 14th Floor, ALBANY, NY, 12207, US

(21) Appl. No.: 11/619,792

(22) Filed: Jan. 4, 2007

(51) Int. Cl. G08C 15/00

(52) U.S. Cl. 370/231

(57) ABSTRACT

The present invention provides a method, system and program product for enhancing communications between endpoints. Specifically, the present invention provides mechanisms (e.g., routing controllers either at a network or application layer) that negotiate and specify which network interface to use at each endpoint (both sending and receiving) in multi-homing interface environments. This approach allows the application traffic to be routed through these two specified network interfaces for the better end-to-end QoS. This network interfaces used can also be dynamic changed (e.g., in real-time) to adapt to changing conditions of the network links.

### BACKGROUND OF THE INVENTION

1. Field of the Invention

The present invention generally relates to network communications management. Specifically, the present invention provides a way to establish Quality of Service (QOS) rerouting for Internet protocol (IP) real-time applications.

2. Related Art

There are large numbers of possible traffic routing paths within the Internet (or another network) between two endpoints. However, normally a single default route is set by the Internet router configuration between the two endpoints. This default route can be congested or disrupted due to the nature of the Internet characteristics. This would result in dramatically degrading the QoS for real time IP applications, e.g., VoIP.

Currently, multi-homing IP network route interfaces are deployed in many enterprise and ISP environments to ease this single default route problem. Some routing mechanisms are in-placed to direct the “out-bound” IP traffic from enterprise/ISP to Internet externally for load balancing, QoS, and fail over. However, the IP traffic is determined by two endpoints. The current multi-homing routing mechanisms only consider network interface selection for outgoing traffic, and can not specify a incoming network interface in the receiving endpoint. This is shown in FIG. 1. Specifically, when (sending) endpoint 10A wishes to send a communication to (receiving) endpoint 10B, endpoint 10A will only consider/select its own network interface 12A. When this occurs, a Dynamic DNS server 14B at the endpoint 10B is used to obtain the receiving end network interface 12B, as shown in FIG. 2. As such, the optimal end to end connectivity can not be achieved since the receiving network DNS 14B does not know which network interface 12A in the sending endpoint 10A is used. Moreover, the selection of the network interfaces 12A-B under existing techniques is very static, and cannot dynamically change based on the network link status. As a result, the current mechanisms can not specify the end-to-end route for the better QoS, and in some cases can not establish a connection for communication between the two endpoints at all due to some network traffic congestion and link failure.

In view of the foregoing, there exists a need for an approach that solves at least one of the deficiencies in the related art.

### SUMMARY OF THE INVENTION

In general, the present invention provides a method, system and program product for enhancing communications between endpoints. Specifically, the present invention provides mechanisms (e.g., routing controllers either at a network or application layer) that negotiate and specify which network interface to use at each endpoint (both sending and receiving) in multi-homing interface environments. This approach allows the application traffic to be routed through these two specified network interfaces for the better end-to-end QoS. This network interfaces used can also be dynamic changed (e.g., in real-time) to adapt to changing conditions of the network links.

One aspect of the present invention provides a method for enhancing network communications between endpoints, comprising: determining an optimal routing path for a network communication from a first endpoint to a second endpoint based on a Quality of Service (QoS); and dynamically selecting a network interface of the first endpoint and a network interface of the second endpoint that correspond to the optimal routing path.

In another aspect of the present invention, the method further comprises: determining a new optimal routing path for the network communication based on the QoS; and dynamically changing at least one of: the network interface of the first endpoint or the second network interface of the second endpoint to correspond to the new optimal routing path.

In another aspect of the present invention, the method further comprises: a routing controller of the first endpoint communicating with a routing controller of the second endpoint to identify the first network interface and the second network interface.

In another aspect of the present invention, the method further comprises: determining an optimal routing path for a network communication from the second endpoint to the first endpoint based on the quality of service; and dynamically selecting a network interface of the second endpoint and a network interface of the first endpoint that correspond to an optimal routing path for the network communication from the second endpoint to the first endpoint.

Another aspect of the present invention provides a system for enhancing network communications between endpoints, comprising: a first endpoint having a first routing controller, the first routing controller being configured to: determine an optimal routing path for a network communication from the first endpoint to a second endpoint based on a Quality of Service (QoS); and dynamically select a network interface of the first endpoint and a network interface of the second endpoint that correspond to the optimal routing path.

In another aspect of the present invention, the routing controller being further configured to: determine a new optimal routing path for the network communication based on the QoS; and dynamically change at least one of: the network interface of the first endpoint or the second network interface of the second endpoint to correspond to the new optimal routing path.

In another aspect of the present invention, the second endpoint comprises a second routing controller, the second routing controller being configured to: determine a second optimal routing path for a network communication from the second endpoint to a first endpoint based on a Quality of Service (QoS); and dynamically select a network interface of the second endpoint and a network interface of the first endpoint that correspond to the second optimal routing path.

In another aspect of the present invention, the first routing controller and the second routing controller are configured to directly communicate with one another.

Another aspect of the present invention provides a program product stored on a computer readable medium for enhancing network communications between endpoints, the computer readable medium comprising program code for causing a computer system to perform the following: determine an optimal routing path for a network communication from a first endpoint to a second endpoint based on a Quality of Service (QoS); and dynamically select a network interface of the first endpoint and a network interface of the second endpoint that correspond to the optimal routing path.

In another aspect of the present invention, the computer readable medium further comprises program code for causing the computer system to perform the following: determine a new optimal routing path for the network communication based on the QoS; and dynamically change at least one of: the network interface of the first endpoint or the second network interface of the second endpoint to correspond to the new optimal routing path.

In another aspect of the present invention, the program product corresponds to the first endpoint, and the program product is configured to communicate with a similar program product corresponding to the second endpoint.

In another aspect of the present invention, the similar program product comprises program code for causing another computer system to perform the following: determine an optimal routing path for a network communication from the second endpoint to the first endpoint based on the quality of service; and dynamically select a network interface of the second endpoint and a network interface of the first endpoint that correspond to an optimal routing path for the network communication from the second endpoint to the first endpoint.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a diagram of a routing mechanism according to the prior art.

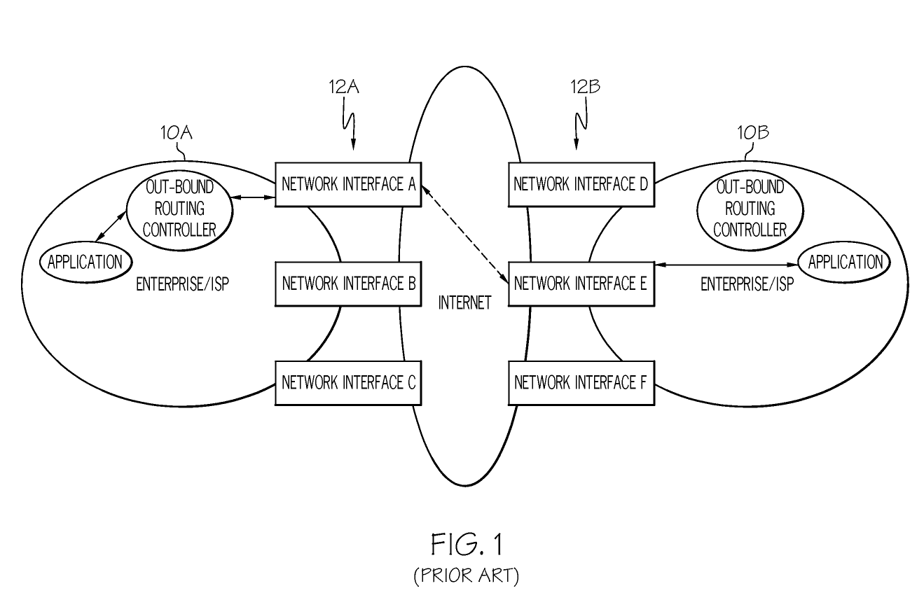

FIG. 2 depicts another diagram of the routing mechanism according to the prior art.

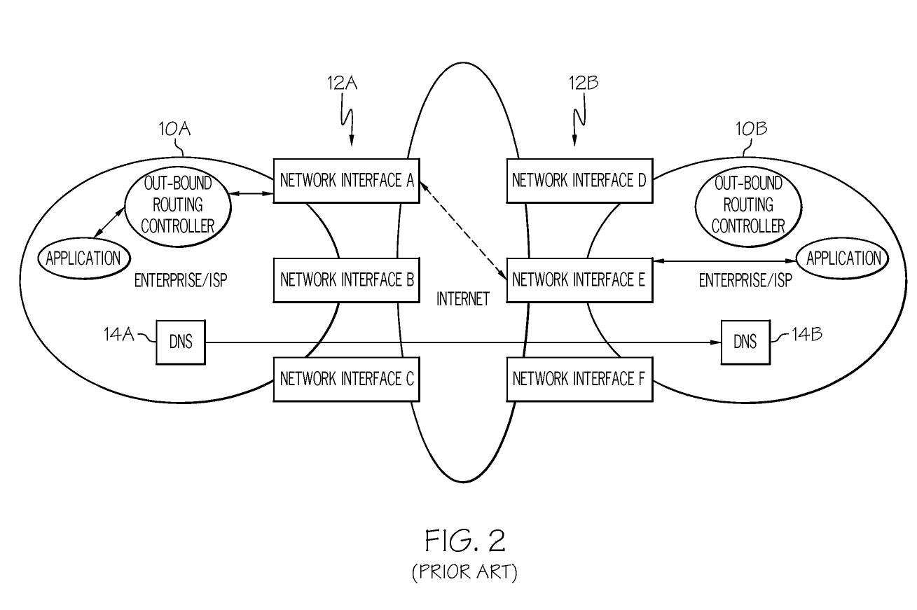

FIG. 3 depicts a routing mechanism according to the present invention.

FIG. 4 depicts a first diagram of an illustrative embodiment according to the present invention.

FIG. 5 depicts another diagram of the illustrative embodiment according to the present invention.

FIG. 6 depicts another diagram of the illustrative embodiment according to the present invention.

FIG. 7 depicts another diagram of the illustrative embodiment according to the present invention.

FIG. 8 depicts another diagram of the illustrative embodiment according to the present invention.

FIG. 9 depicts another diagram of the illustrative embodiment according to the present invention.

FIG. 10 depicts another diagram of the illustrative embodiment according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following sections:

I. General Description

II. Illustrative Embodiment

### I. General Description

As indicated above, the present invention provides a method, system and program product for enhancing communications between endpoints. Specifically, the present invention provides mechanisms (e.g., routing controllers either at a network or application layer) that negotiate and specify which network interface to use at each endpoint (both sending and receiving) in multi-homing interface environments. This approach allows the application traffic to be routed through these two specified network interfaces for the better end-to-end QoS. This network interfaces used can also be dynamic changed (e.g., in real-time) to adapt to changing conditions of the network links.

In one aspect of the present invention provides a method for enhancing network communications between endpoints, comprising: determining an optimal routing path for a network communication from a first endpoint to a second endpoint based on a Quality of Service (QoS); and dynamically selecting a network interface of the first endpoint and a network interface of the second endpoint that correspond to the optimal routing path.

In another aspect of the present invention, the method further comprises: determining a new optimal routing path for the network communication based on the QoS; and dynamically changing at least one of: the network interface of the first endpoint or the second network interface of the second endpoint to correspond to the new optimal routing path.

In another aspect of the present invention, the method further comprises: a routing controller of the first endpoint communicating with a routing controller of the second endpoint to identify the first network interface and the second network interface.

In another aspect of the present invention, the method further comprises: determining an optimal routing path for a network communication from the second endpoint to the first endpoint based on the quality of service; and dynamically selecting a network interface of the second endpoint and a network interface of the first endpoint that correspond to an optimal routing path for the network communication from the second endpoint to the first endpoint.

Another aspect of the present invention provides a system for enhancing network communications between endpoints, comprising: a first endpoint having a first routing controller, the first routing controller being configured to: determine an optimal routing path for a network communication from the first endpoint to a second endpoint based on a Quality of Service (QoS); and dynamically select a network interface of the first endpoint and a network interface of the second endpoint that correspond to the optimal routing path.

In another aspect of the present invention, the routing controller being further configured to: determine a new optimal routing path for the network communication based on the QoS; and dynamically change at least one of: the network interface of the first endpoint or the second network interface of the second endpoint to correspond to the new optimal routing path.

In another aspect of the present invention, the second endpoint comprises a second routing controller, the second routing controller being configured to: determine a second optimal routing path for a network communication from the second endpoint to a first endpoint based on a Quality of Service (QoS); and dynamically select a network interface of the second endpoint and a network interface of the first endpoint that correspond to the second optimal routing path.

In another aspect of the present invention, the first routing controller and the second routing controller are configured to directly communicate with one another.

Another aspect of the present invention provides a program product stored on a computer readable medium for enhancing network communications between endpoints, the computer readable medium comprising program code for causing a computer system to perform the following: determine an optimal routing path for a network communication from a first endpoint to a second endpoint based on a Quality of Service (QoS); and dynamically select a network interface of the first endpoint and a network interface of the second endpoint that correspond to the optimal routing path.

In another aspect of the present invention, the computer readable medium further comprises program code for causing the computer system to perform the following: determine a new optimal routing path for the network communication based on the QoS; and dynamically change at least one of: the network interface of the first endpoint or the second network interface of the second endpoint to correspond to the new optimal routing path.

In another aspect of the present invention, the program product corresponds to the first endpoint, and the program product is configured to communicate with a similar program product corresponding to the second endpoint.

In another aspect of the present invention, the similar program product comprises program code for causing another computer system to perform the following: determine an optimal routing path for a network communication from the second endpoint to the first endpoint based on the quality of service; and dynamically select a network interface of the second endpoint and a network interface of the first endpoint that correspond to an optimal routing path for the network communication from the second endpoint to the first endpoint.

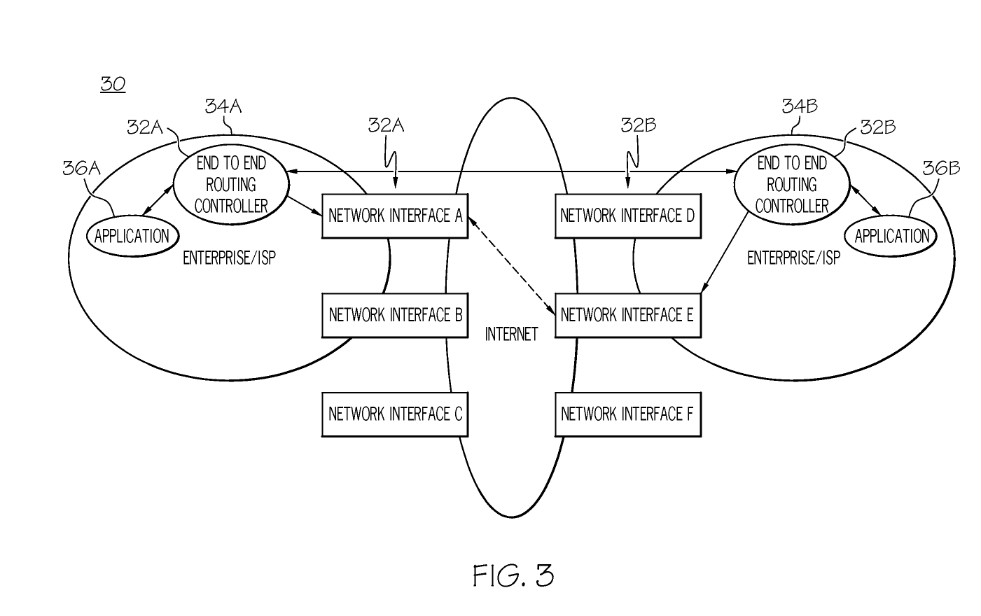

Referring now to FIG. 3, a system 30 for enhancing communications between endpoints according to the present invention is shown. This mechanism includes an end-to-end routing controller 32A-B that needs to be installed at both transmission and receiving endpoints 34A-B (networks). These end-to-end routing controllers 32A-B generally comprise program code stored on one or more computer readable mediums that comprise program code for causing a computerized system/device to perform one or more functions. In general, routing controllers 32A-B provide the following functionality and features (among others):

(1) Routing controllers 32A-B form an overlay network and communicate each other to obtain the conditions of the network links among them. They also maintain a “real time” optimal path table for all of its multi-homing interfaces across all the connections.

(2) All the incoming or outgoing traffic for applications 36A-B go through routing controllers 32A-B. Note that routing controller can manage and set up the routing table of the IP network routers such that only the “signal/control” part of the application traffic passes through routing controllers 32A-B, and the application data traffic passes through the IP network routers. For example, in the SIP/VoIP application, only SIP protocol traffic needs to reach routing controllers 32A-B to set up the routing table in the IP network routers to route the RTP voice traffic. In some implementations, both application signaling and data traffic can pass through routing controllers 32A-B if the remote IP network routing table setting is not available.

(3) For a given application connection between two endpoints 34A-B, two network interfaces 38A and 38B are selected based on the optimal path table (i.e., based on a QoS), (e.g., network interfaces A and E in FIG. 3). Assume that the physical IP addresses for network interface A is IPAddr A, and network interface E is IPAddr E. The out-bound network routing between routing controllers 32A-B, and all its network interface can be implemented by directly physical network link connection such that there is no header manipulation required in the sending end. However, the destination IP address should be modified to the IPAddr E in order for the Internet to route the traffic to network interface E. Since both routing controllers 32A-B have prior knowledge about this specific connection, (i.e., the 4-tuple of port and IP address), as well as the application connection ID (e.g., the call ID of the SIP connection), the receiving end routing controller 32B can correctly decide which endpoint 34A from the incoming traffic and correctly route the traffic to it.

(4) The network interface selection(s) and corresponding routing paths can be dynamically changed (in real-time) based on the QoS to accommodate changing link quality/characteristics.

(5) As such a high QoS end-to-end routing is completed.

### II. Illustrative Embodiment

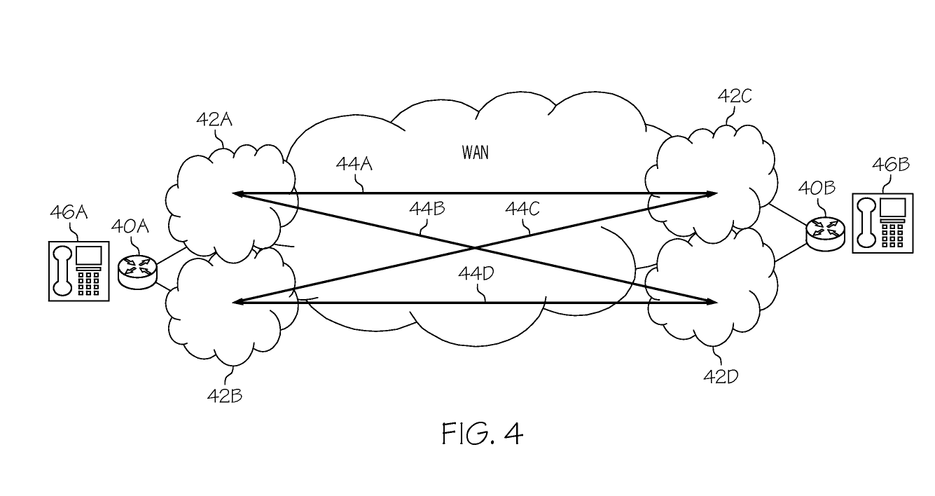

An illustrative embodiment will now be described with reference to FIGS. 4-10. Specifically, this embodiment is for an illustrative VoIP application scenario between multi-homed sites 40A-B. Each site 40A-B has two access providers 42A-D with a total of 4 possible path pairs 44A-D between these sites 40A-B. The present invention enables both sites 40A-B to select, in real-time which path pair 44A-D to use.

In general, this embodiment makes use of SIP as the underline protocol to transport and exchange the multi-homed interface information and establish the end to end communication channel. In this example, two IP phones 46A-B (phone A and phone B) are located in two separated networks 40A-B connected by WAN.

The system flow includes of the following steps:

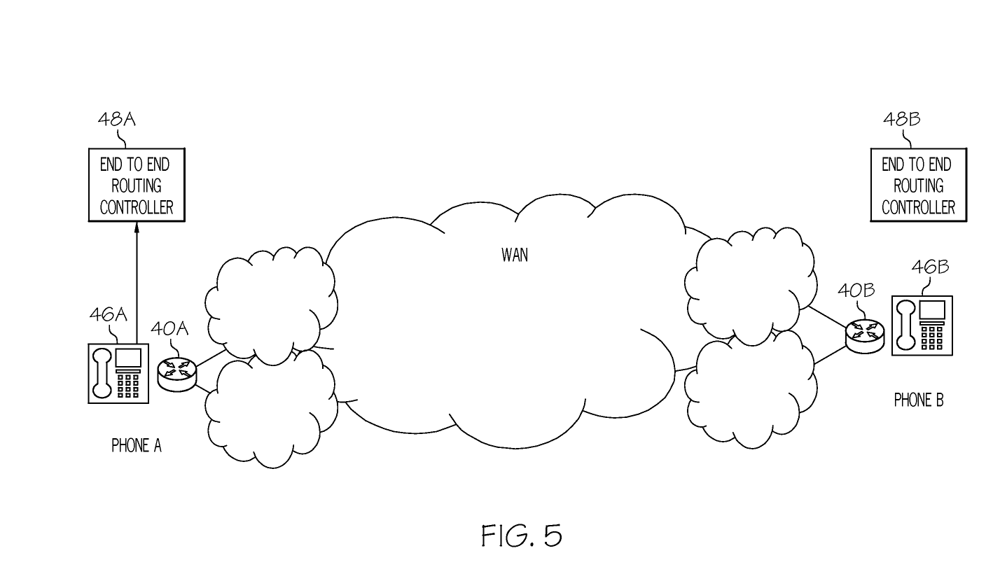

(1) Step 1 (as shown in FIG. 5)

When phone 46A initiates a call to phone 46B, phone 46A will first send the SIP INVITE request to routing controller 48A. The SIP INVITE request will carry the phone 46A's IP address and media port that it wishes to receive the voice from phone 46B. Note that since phone VA does not know which external network interface to use, the IP address is the internal IP address that it received from system (e.g., DHCP) when it is powered on.

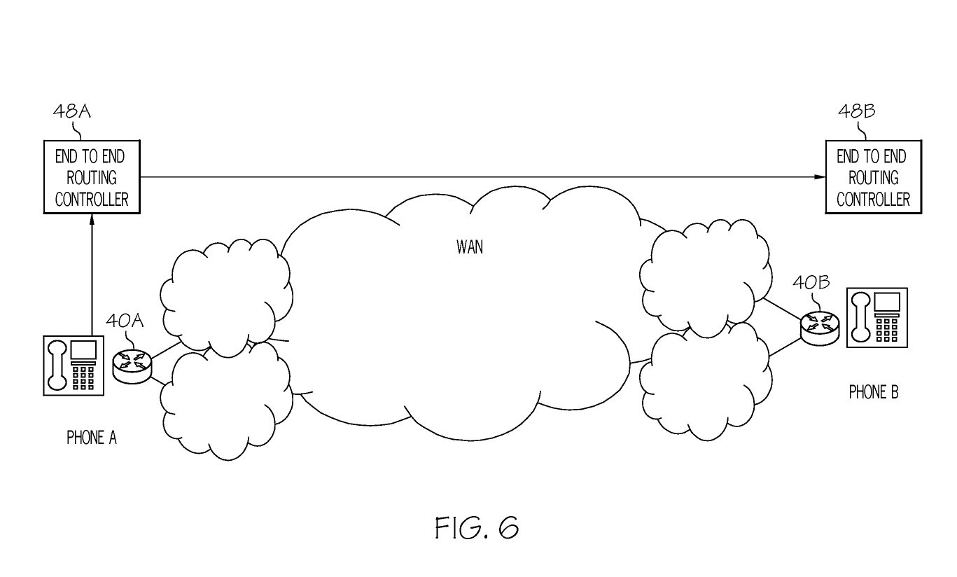

(2) Step 2 (as shown in FIG. 6)

Routing controller 48A will modify the SIP INVITE request with multiple external IP addresses that each associates with one network interface. Routing controller 48A will send this modified SIP INVITE to the counter part routing controller 48B in receiving end network 40B.

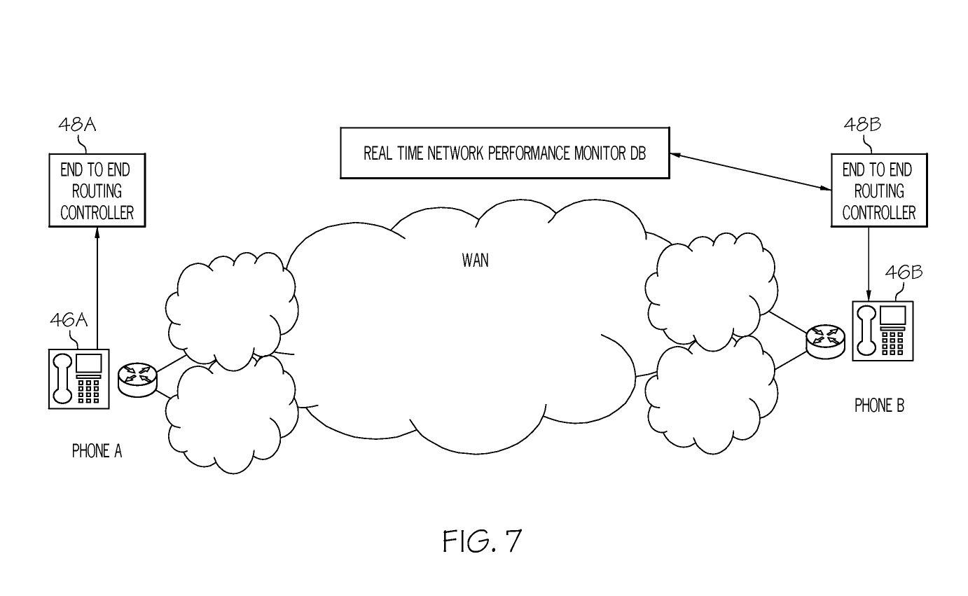

(3) Step 3 (as shown in FIG. 7)

The receiving routing controller 48B selects one path pair 44A-D (FIG. 4) based on the dynamic real time network monitoring DB. Routing controller 48B will remove all of phone 46A's IP addresses and ports, and will remain only the IP address and port that correspond the selected path pair. It will send phone 46B its corresponding external IP address. Routing controller 48B then relays this SIP INVITE to phone 46B

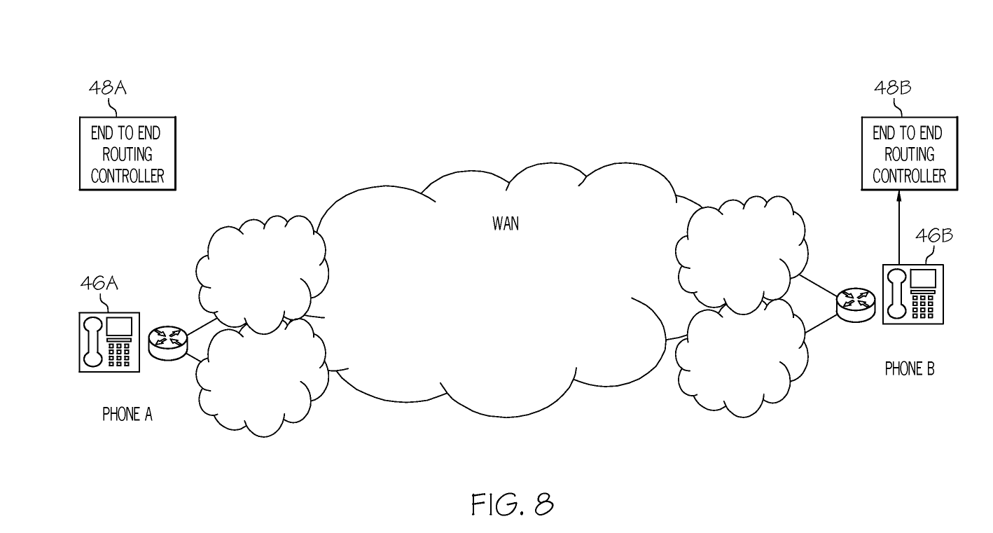

(4) Step 4 (as shown in FIG. 8)

Phone 46B will send the INVITE RESPONSE with its external IP address to its routing controller 48B (which now has the knowledge which path pair should be selected).

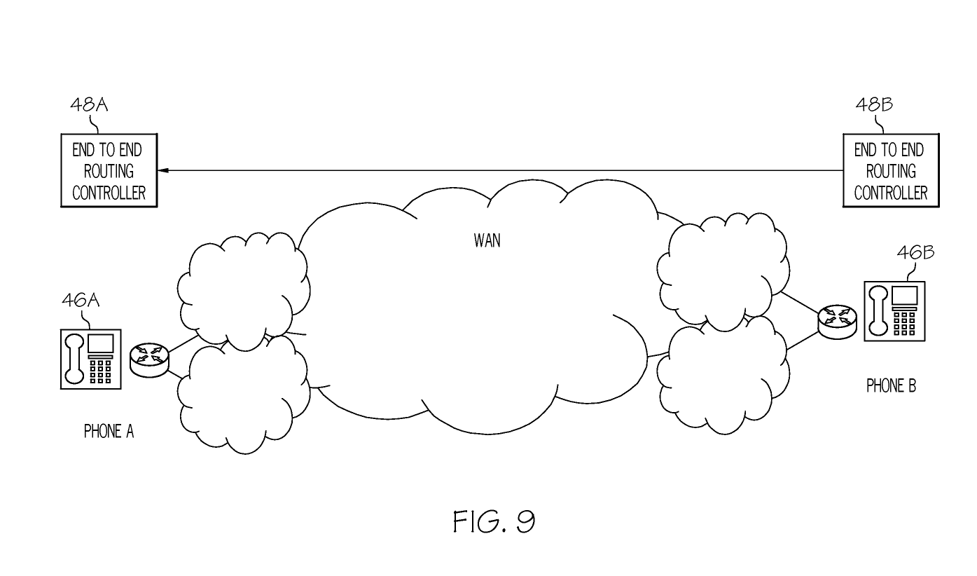

(5) Step 5 (as shown in FIG. 9)

Routing controller 48B will add phone 46A's selected external IP address and port before it sends it back to its counter part routing controller 48A.

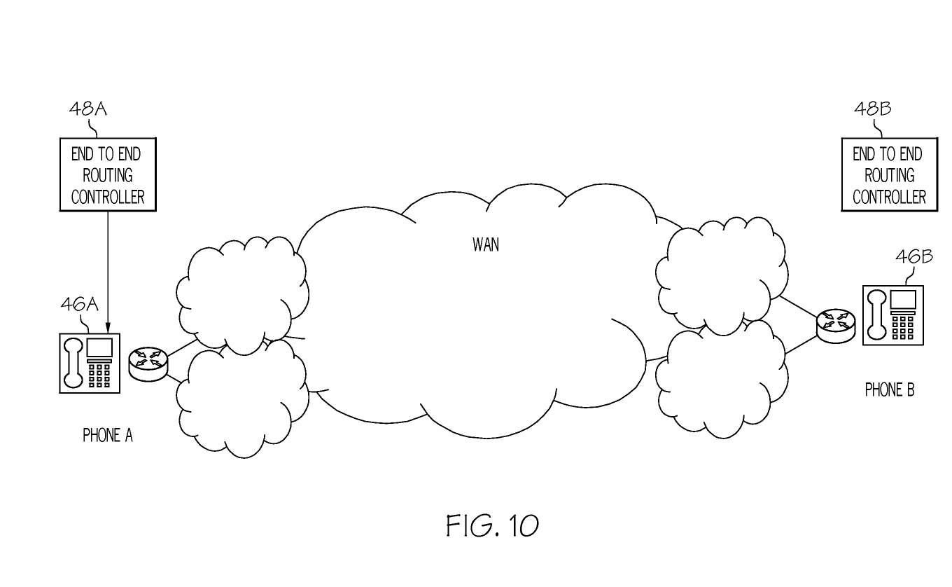

(6) Step 6 (as shown in FIG. 10)

Routing controller 48A returns the response to phone 46A. Consequently, phone 46A and 46B both use the selected path pair external IP address and port for the voice communication.

While shown and described herein as communications enhancement solution, it is understood that the invention further provides various alternative embodiments. For example, in one embodiment, the invention provides a computer-readable/useable medium that includes computer program code to enable a computer infrastructure to enhance network communications between endpoints. To this extent, the computer-readable/useable medium includes program code that implements each of the various process of the invention. It is understood that the terms computer-readable medium or computer useable medium comprise one or more of any type of physical embodiment of the program code that is executed by a processor, and which is connected to the computer-readable medium via a bus or the like. In particular, the computer-readable/useable medium can comprise program code embodied on one or more portable storage articles of manufacture (e.g., a compact disc, a magnetic disk, a tape, etc.), on one or more data storage portions of a device, such as computer memory (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to enhance network communications between endpoints. In this case, the service provider can create, maintain, deploy, support, etc., a computer infrastructure, that performs the process of the invention for one or more customers. In return, the service provider can receive payment from the target organization(s) under a subscription and/or fee agreement and/or the service provider can receive payment from the sale of advertising content to one or more third parties.

In still another embodiment, the invention provides a computer-implemented method for enhancing network communications between endpoints. In this case, a computer infrastructure can be provided and one or more systems for performing the process of the invention can be obtained (e.g., created, purchased, used, modified, etc.) and deployed to the computer infrastructure. To this extent, the deployment of a system can comprise one or more of (1) installing program code on a device, from a computer-readable medium; (2) adding one or more devices to the computer infrastructure; and (3) incorporating and/or modifying one or more existing systems of the computer infrastructure to enable the computer infrastructure to perform processes according to one or more aspects of the invention.

As used herein, it is understood that the terms “program code” and “computer program code” are synonymous and mean any expression, in any language, code or notation, of a set of instructions intended to cause a device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular providing and/or I/O device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for enhancing network communications between endpoints, comprising:
determining an optimal routing path for a network communication from a first endpoint to a second endpoint based on a Quality of Service (QoS); and
dynamically selecting a network interface of the first endpoint and a network interface of the second endpoint that correspond to the optimal routing path.

2. The method of claim 1, further comprising:
determining a new optimal routing path for the network communication based on the QoS; and
dynamically changing at least one of: the network interface of the first endpoint or the second network interface of the second endpoint to correspond to the new optimal routing path.

3. The method of claim 1, further comprising a routing controller of the first endpoint communicating with a routing controller of the second endpoint to identify the first network interface and the second network interface.

4. The method of claim 1, further comprising:
determining an optimal routing path for a network communication from the second endpoint to the first endpoint based on the quality of service; and
dynamically selecting a network interface of the second endpoint and a network interface of the first endpoint that correspond to an optimal routing path for the network communication from the second endpoint to the first endpoint.

5. A system for enhancing network communications between endpoints, comprising:
a first endpoint having a first routing controller, the first routing controller being configured to:
determine an optimal routing path for a network communication from the first endpoint to a second endpoint based on a Quality of Service (QoS); and
dynamically select a network interface of the first endpoint and a network interface of the second endpoint that correspond to the optimal routing path.

6. The system of claim 5, the routing controller being further configured to:
determine a new optimal routing path for the network communication based on the QoS; and
dynamically change at least one of: the network interface of the first endpoint or the second network interface of the second endpoint to correspond to the new optimal routing path.

7. The system of claim 5, the second endpoint comprising a second routing controller, the second routing controller being configured to:
determine a second optimal routing path for a network communication from the second endpoint to a first endpoint based on a Quality of Service (QoS); and
dynamically select a network interface of the second endpoint and a network interface of the first endpoint that correspond to the second optimal routing path.

8. The system of claim 7, the first routing controller and the second routing controller being configured to directly communicate with one another.

9. A program product stored on a computer readable medium for enhancing network communications between endpoints, the computer readable medium comprising program code for causing a computer system to perform the following:
determine an optimal routing path for a network communication from a first endpoint to a second endpoint based on a Quality of Service (QoS); and
dynamically select a network interface of the first endpoint and a network interface of the second endpoint that correspond to the optimal routing path.

10. The program product of claim 9, the computer readable medium further comprising program code for causing the computer system to perform the following:
determine a new optimal routing path for the network communication based on the QoS; and
dynamically change at least one of: the network interface of the first endpoint or the second network interface of the second endpoint to correspond to the new optimal routing path.

11. The program product of claim 9, the program product corresponding to the first endpoint, and the program product being configured to communicate with a similar program product corresponding to the second endpoint.

12. The program product of claim 9, the similar program product comprising program code for causing another computer system to perform the following:
determine an optimal routing path for a network communication from the second endpoint to the first endpoint based on the quality of service; and
dynamically select a network interface of the second endpoint and a network interface of the first endpoint that correspond to an optimal routing path for the network communication from the second endpoint to the first endpoint.
